(19) United States
(12) Patent Application Publication
(10) Pub. No.: US 2015/0301464 A1
(43) Pub. Date: Oct. 22, 2015

(54) Chemically Prepared Energy Efficient Toner Formulation and Method to Make the Same

(71) Applicant: Lexmark International, Inc., Lexington, KY (US)

(72) Inventors: Trent Duane Peter, Johnstown, CO (US); Kasturi Rangan Srinivasan, Longmont, CO (US); Tao Yu, Wellesley, MA (US)

(73) Assignee: Lexmark International, Inc., Lexington, KY (US)

(21) Appl. No.: 14/253,958

(22) Filed: Apr. 16, 2014

(51) Int. Cl. G03G 9/08; G03G 9/087

(52) U.S. Cl. CPC G03G 9/0806; G03G 9/08711

(57) ABSTRACT

The present invention relates generally to chemically prepared toner and method of making the toner for use in electrophotography and more particularly to chemically prepared toner that can simultaneously fix at an energy saving low temperature and also be resistant to hot offset. The chemically prepared toner includes a mixture of a low molecular weight styrene acrylic resin and a low melting polyester resin. The amount of the low melt polyester resin must not exceed 40% by weight of the energy efficient toner of the present invention.

### CROSS REFERENCES TO RELATED APPLICATIONS

None

### BACKGROUND

1. Field of the Disclosure

The present invention relates generally to chemically prepared toner and methods of making the same for use in electrophotography and more particularly to chemically prepared toner that can simultaneously fix at an energy saving low temperature and also be resistant to hot offset. The chemically prepared toner includes a mixture of a relatively low molecular weight styrene acrylic resin and a low melting polyester resin. The amount of the low melt polyester resin must not be more than 40% by weight of the toner formulation.

2. Description of the Related Art

Toners for use in electrophotographic printers include two primary types, mechanically milled toners and chemically prepared toners. Chemically prepared toners have significant advantages over mechanically milled toners including better print quality, higher toner transfer efficiency and lower torque properties for various components of the electrophotographic printer such as a developer roller, a fuser belt and a charge roller. The particle size distribution of chemically prepared toner is typically narrower than the particle size distribution of mechanically milled toners. The size and shape of chemically prepared toner are also easier to control than mechanically milled toners.

There are several known types of chemically prepared toner including suspension polymerization toner (SPT), emulsion aggregation toner (EAT)/latex aggregation toner (LAT), toner made from a dispersion of pre-formed polymer in solvent (DPPT) and “chemically milled” toner. While emulsion aggregation toner requires a more complex process than other chemically prepared toner, the resulting toner has a relatively narrower size distribution. Emulsion aggregation toners can also be manufactured with a smaller particle size allowing improved print resolution. The emulsion aggregation process also permits better control of the shape and structure of the toner particles which allows them to be tailored to fit the desired cleaning, doctoring and transfer properties. The shape of the toner particles may be optimized to ensure proper and efficient cleaning of the toner from various electrophotographic printer components, such as the developer roller, charge roller and doctoring blades, in order to prevent filming or unwanted deposition of toner on these components.

A toner's fusing properties include its fuse window. The fuse window is the range of temperatures at which fusing is satisfactorily conducted without incomplete fusion and without transfer of toner to the heating element, which may be a roller, belt or other member contacting the toner during fusing. Thus below the low temperature end of the fuse window, the toner is incompletely melted. Above the high temperature end of the fuse window, the toner flows onto the fixing member where it mars subsequent sheets being fixed. This phenomenon wherein the toner flows onto the fixing member and is subsequently transferred to the paper is called hot offset. Additionally, it is preferred that the low end of the fuse window be as low as possible to reduce the required temperature of the fuser in the electrophotographic printer to improve the printer's safety and to conserve energy due to the reduction in power consumption during fusing.

In a typical process for preparing EAT, emulsion aggregation is carried out in an aqueous system resulting in good control of both the size and shape of the toner particles. The toner components typically include a polymer binder, one or more colorants and a release agent. A high molecular weight styrene acrylic copolymer binder is often used as the polymer latex binder in the toner formulation because its' incorporation into the toner formulation allows the toner to be resistant to hot offset. However one drawback to having this type of resin in the toner formulation is that the toner also fuses at a high temperature—thereby making the printer consume more power during fusing. It is unusual to maintain resistance to hot offset with a high percentage of styrene acrylic resin in a toner formulation without elevating softening and flow onset temperature.

Toners are also formulated from polyester binder resins. Polyester binder resins typically possess better mechanical properties than toners formed from a styrene acrylic copolymer binder of similar melt viscosity characteristics. This makes them more durable and resistant to filming of printer components. Polyester toners also have better compatibility with color pigments resulting in a wider color gamut. Moreover, toners formulated with low molecular weight polyester binder resins also fuse at an energy saving lower temperature compared to toners formulated with styrene acrylic binder resins. However, toners formulated with energy saving polyester resins are unfortunately prone to hot offset.

Until recently, polyester binder resins were frequently used in preparing mechanically milled toners but rarely in chemically prepared toners. Polyester binder resins are manufactured using condensation polymerization. This method is time consuming due to the involvement of long polymerization cycles and therefore limits the use of polyester binder resins to polyester polymers having low to moderate molecular weights, which limits the fusing properties of the toner. Further, polyester binder resins are more difficult to disperse in an aqueous system due to their polar nature, pH sensitivity and gel content thereby limiting their applicability in the emulsion aggregation process.

However, with advancement in toner manufacturing technology, it has become possible to obtain stable emulsions formed using polyester binder resins by first dissolving them in an organic solvent, such as methyl ethyl ketone (MEK), methylene chloride, ethyl acetate, or tetrahydrofuran (THF), and then performing a phase-inversion process where water is added slowly to the organic solvent. The organic solvent is then evaporated to allow the polyester binder resins to form stable emulsions. U.S. Pat. No. 7,939,236 entitled “Chemically Prepared Toner and Process Therefore,” which is assigned to the assignee of the present application and incorporated by reference herein in its entirety teaches a similar process for obtaining a stable emulsion using an organic solvent. These advances have permitted the use of polyester binder resins to form emulsion aggregation toner. For example, U.S. Pat. No. 7,923,191 entitled “Polyester Resin Produced by Emulsion Aggregation” and U.S. patent application Ser. No. 12/206,402 entitled “Emulsion Aggregation Toner Formulation,” which are assigned to the assignee of the present application and incorporated by reference herein in their entirety, disclose processes for preparing emulsion aggregation toner using polyester binder resins. Additionally, polyester resins are readily commercially available in emulsion form.

Heretofore it has been difficult to formulate a toner which can simultaneously fuse at an energy saving low temperature and be resistant to hot offset. This balance is difficult to achieve because usually toner having the resistance to hot offset also fuse at a high temperature, leading the printer to use more energy. Additionally, toners fusing at lower temperature almost always have hot offset problems. It has been hard to formulate a toner that can achieve these two important properties simultaneously. Accordingly, it will be appreciated that an emulsion aggregation toner formulation and process that fuses at an energy saving low temperature while also be resistant to hot offset is desired.

### SUMMARY

The present invention relates generally to chemically prepared toner and method of making the toner for use in electrophotography and more particularly to chemically prepared toner that can simultaneously fix at an energy saving low temperature and also be resistant to hot offset. The chemically prepared toner includes a mixture of a low molecular weight styrene acrylic resin and a low melting polyester resin. The amount of the low melt polyester resin must not exceed 40% by weight of the energy efficient toner of the present invention.

### DESCRIPTION

The following description and drawings illustrate embodiments sufficiently to enable those skilled in the art to practice the present invention. It is to be understood that the disclosure is not limited to the details of construction and the arrangement of components set forth in the following description or illustrated in the drawings. The invention is capable of other embodiments and of being practiced or of being carried out in various ways. For example, other embodiments may incorporate structural, chronological, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense and the scope of the present invention is defined by the appended claims. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present disclosure relates to a chemically prepared toner containing a low melting and low molecular weight polyester resin in combination with a low molecular weight styrene acrylic resin and method to make the same, wherein the amount of the polyester resin must not exceed 40% by weight of the energy efficient toner formulation of the present invention. Surprisingly incorporating low molecular weight resins into the toner still allows the toner to be resistant to hot offset. Usually the blending of a high molecular weight styrene acrylic resin with a lower molecular weight polymer results effectively results in a final resin matrix in the toner with increased softening and flow-onset temperature when compared to toner having only a low molecular weight styrene acrylic resin. This increase in flow-onset temperature is not desirable for an energy efficient toner. In the toner of the present invention, the addition of a small portion of a low melting and lower molecular weight polyester resin into a styrene acrylic resin majority having a higher melt temperature and molecular weight is similar to the result obtained when adding a high molecular weight styrene acrylic resin into the toner. This is so because resistance to hot offset is achieved but surprisingly the softening and flow onset temperature is not elevated, thereby rendering the toner more favorable to low energy fusing requirements. The energy efficient toner may be utilized in an electrophotographic printer such as a printer, copier, multi-function device or an all-in-one device. The toner may be provided in a cartridge that supplies toner to the electrophotographic printer. Example methods of forming toner using conventional emulsion aggregation techniques may be found in U.S. Pat. Nos. 6,531,254 and 6,531,256, which are incorporated by reference herein in their entirety.

In the present emulsion aggregation process, the toner particles are provided by chemical methods as opposed to physical methods such as pulverization, milling or grinding. Generally, the toner of the present invention includes two polymer binders—a polyester resin binder and a styrene acrylic resin binder, a release agent, a colorant, one or more optional additives such as a charge control agent (CCA). Emulsions of a polyester and the styrene acrylic binders are formed in water, optionally with organic solvent, with an inorganic base such as sodium hydroxide, potassium hydroxide, ammonium hydroxide, or an organic amine compound. A stabilizing agent having an anionic functional group (A−), e.g., an anionic surfactant or an anionic polymeric dispersant may also be included. It will be appreciated that a cationic (C+) functional group, e.g., a cationic surfactant or a cationic polymeric dispersant, may be substituted as desired. Commercially available polyester resin emulsions can also be used. The ratio of the amount of low molecular weight polyester binder in the toner to the amount of low molecular weight styrene acrylic binder in the toner is between about 90:10 (wt.) and about 60:40 (wt.) including all values and increments there between, most preferably the amount of the styrene acrylic resin must be at least 60% and the low melt polyester not be more than 40% by weight of the toner formulation.

The colorant, release agent, and the optional charge control agent are dispersed separately in their own aqueous environments or in one aqueous mixture, as desired, in the presence of a stabilizing agent having similar functionality (and ionic charge) as the stabilizing agent employed in the polyester and the styrene acrylic resin emulsion. The polyester and the styrene acrylic emulsions, the release agent dispersion, the colorant dispersion and the optional charge control agent dispersion are then mixed and stirred to ensure a homogenous composition. Polyester and styrene acrylic emulsions are not immiscible when mixed in an EA process as opposed to a conventional grinding/milling process. As used herein, the term dispersion refers to a system in which particles are dispersed in a continuous phase of a different composition (or state) and may include an emulsion. Acid is then added to reduce the pH and cause flocculation. Flocculation refers to the process by which destabilized particles conglomerate (e.g., due to the presence of available counterions) into relatively larger aggregates. In this case, flocculation includes the formation of a gel where resin, colorant, release agent and charge control agent form an aggregate mixture, typically from particles 1-2 microns (m) in size. Unless stated otherwise, reference to particle size herein refers to the largest cross-sectional dimension of the particle. The aggregated toner particles may then be heated to a temperature that is less than or around (e.g., ±5° C.) the glass transition temperature (Tg) of the polymer latex to induce the growth of clusters of the aggregate particles. Once the aggregate particles reach the desired toner size, base may be added to increase the pH and reionize the anionic stabilizing agent to prevent further particle growth or one can add additional anionic stabilizing agents. The temperature is then raised above the glass transition temperature of the polymer latexes (the polyester resin and the styrene acrylic resin) to fuse the particles together within each cluster. This temperature is maintained until the particles reach the desired circularity. The toner particles are then washed and dried.

The toner particles produced may have an average particle size of between about 3 μm and about 20 μm (volume average particle size) including all values and increments there between, such as between about 4 μm and about 15 μm or, more particularly, between about 5 μm and about 7 μm. The toner particles produced may have an average degree of circularity between about 0.90 and about 1.00, including all values and increments there between, such as about 0.93 to about 0.98. The average degree of circularity and average particle size may be determined by a Sysmex Flow Particle Image Analyzer (e.g., FPIA-3000) available from Malvern Instruments.

The various components for the emulsion aggregation method to prepare the above referenced toner will be described below. It should be noted that the various features of the indicated components may all be adjusted to facilitate the step of aggregation and formation of toner particles of desired size and geometry. It may therefore be appreciated that by controlling the indicated characteristics, one may first form relatively stable dispersions, wherein aggregation may proceed along with relatively easy control of final toner particle size for use in an electrophotographic printer or printer cartridge.

Polymer Binder Resins

As mentioned above, the toner herein includes two polymer binders. The terms resin and polymer are used interchangeably herein as there is no technical difference between the two. One of the polymer binders includes a polyester. The polyester binder may include a semi-crystalline polyester binder, a crystalline polyester binder or an amorphous polyester binder. Alternatively, the polyester binder may include a polyester copolymer binder resin. The polyester binder may be formed using acid monomers such as terephthalic acid, trimellitic anhydride, dodecenyl succinic anhydride and fumaric acid. Further, the polyester binder may be formed using alcohol monomers such as ethoxylated and propoxylated bisphenol A. Useful polyester binders may include those polyesters that have a peak molecular weight (Mp) as determined by gel permeation chromatography (GPC) from about 4,000 to about 15,000. Whereas the polyesters can be obtained with softening and melting temperatures ranging from about 50° C. to about 150° C., preferably the polyester should have a melt range from about 90° C. to about 110° C. Example polyester resins include, but are not limited to, FineTone 382ES, FineTone 382ES-HWM, FineTone PL-100, FineTone 3344-9A, EM 186404 and EM 186109 manufactured by Reichhold Chemical, Inc. Polyesters such as FineTone 382ES, FineTone 382ES-HWM are two examples of polyester resins that have a melt temperature from about 90° C. to about 109° C. Particularly preferred are commercially available polyester binders in emulsion form sold by Reichhold Chemical, Inc. under the trade names EM 188334 and EM 187468.

The other polymer binder includes a thermoplastic type polymer such as a styrene and/or substituted styrene polymer, such as a homopolymer (e.g., polystyrene) and/or copolymer (e.g., styrene butadiene copolymer and/or styrene acrylic copolymer, a styrene butyl methacrylate copolymer and/or polymers made from styrene butyl acrylate and other acrylic monomers such as hydroxy acrylates or hydroxyl methacrylates); polyvinyl acetate, polyalkenes, poly(vinyl chloride), polyurethanes, polyamides, silicones, epoxy resins, or phenolic resins. The styrene acrylic emulsion has a relatively low peak molecular weight ranging from about 10,000 to about 35,000 and a melt range temperature from about 80° C. to about 150° C. Additionally the styrene acrylic resin should have a glass transition temperature of less than 65° C., preferably in the range of about 40° C. to about 65° C., including all increments therein. The inventors have discovered that the styrene acrylic resin used for energy efficient toner of the present invention needs to have both a higher molecular weight and higher melt temperature than the polyester resin. Suitable styrene acrylic resins are readily available from DSM Neoresins under the trade names Neocryl A2980, Neocryl A2990 and Neocryl A3000. As discussed above, the toner is formed from a mixture of a polyester binder resin and a styrene acrylic binder resin. Further, the ratio of the amount of styrene acrylic binder to the amount of polyester binder may be between about 90:10 (wt.) to about 60:40 (wt.). The amount of the low molecular weight styrene acrylic resin must be at least 60% by weight and the low melt polyester resin must not exceed 40% by weight of the toner formulation of the present invention.

Colorant

Colorants are compositions that impart color or other visual effects to the toner and may include carbon black, dyes (which may be soluble in a given medium and capable of precipitation), pigments (which may be insoluble in a given medium) or a combination of the two. A colorant dispersion may be prepared by mixing the pigment in water with a dispersant. Alternatively, a self-dispersing colorant may be used thereby permitting omission of the dispersant. The colorant may be present in the dispersion at a level of about 5% to about 20% by weight including all values and increments there between. For example, the colorant may be present in the dispersion at a level of about 10% to about 15% by weight. The dispersion of colorant may contain particles at a size of about 50 nanometers (nm) to about 500 nm including all values and increments there between. Further, the colorant dispersion may have a pigment weight percent divided by dispersant weight percent (P/D ratio) of about 1:1 to about 8:1 including all values and increments there between, such as about 2:1 to about 5:1. The colorant may be present at less than or equal to about 15% by weight of the final toner formulation including all values and increments there between.

Release Agent

The release agent may include any compound that facilitates the release of toner from a component in an electrophotographic printer (e.g., release from a roller surface). For example, the release agent may include polyolefin wax, ester wax, polyester wax, polyethylene wax, metal salts of fatty acids, fatty acid esters, partially saponified fatty acid esters, higher fatty acid esters, higher alcohols, paraffin wax, carnauba wax, amide waxes and polyhydric alcohol esters.

The release agent may therefore include a low molecular weight hydrocarbon based polymer (e.g., Mn≦10,000) having a melting point of less than about 140° C. including all values and increments between about 50° C. and about 140° C. For example, the release agent may have a melting point of about 60° C. to about 135° C., or from about 65° C. to about 100° C., etc. The release agent may be present in the dispersion at an amount of about 5% to about 35% by weight including all values and increments there between. For example, the release agent may be present in the dispersion at an amount of about 10% to about 18% by weight. The dispersion of release agent may also contain particles at a size of about 50 nm to about 1 μm including all values and increments there between. In addition, the release agent dispersion may be further characterized as having a release agent weight percent divided by dispersant weight percent (RA/D ratio) of about 1:1 to about 30:1. For example, the RA/D ratio may be about 3:1 to about 8:1. The release agent may be provided in the range of about 2% to about 20% by weight of the final toner formulation including all values and increments there between. A useful release agent is a polyethylene based wax manufactured by Baker Hughes Corp. under the tradename Ceramer 67.

Surfactant/Dispersant

A surfactant, a polymeric dispersant or a combination thereof may be used. The polymeric dispersant may generally include three components, namely, a hydrophilic component, a hydrophobic component and a protective colloid component. Reference to hydrophobic refers to a relatively non-polar type chemical structure that tends to self-associate in the presence of water. The hydrophobic component of the polymeric dispersant may include electron-rich functional groups or long chain hydrocarbons. Such functional groups are known to exhibit strong interaction and/or adsorption properties with respect to particle surfaces such as the colorant and the polyester binder resin of the polyester resin emulsion. Hydrophilic functionality refers to relatively polar functionality (e.g., an anionic group) which may then tend to associate with water molecules. The protective colloid component includes a water soluble group with no ionic function. The protective colloid component of the polymeric dispersant provides extra stability in addition to the hydrophilic component in an aqueous system. Use of the protective colloid component substantially reduces the amount of the ionic monomer segment or the hydrophilic component in the polymeric dispersant. Further, the protective colloid component stabilizes the polymeric dispersant in lower acidic media. The protective colloid component generally includes polyethylene glycol (PEG) groups. The dispersant employed herein may include the dispersants disclosed in U.S. Pat. No. 6,991,884 and U.S. Pat. No. 5,714,538, which are incorporated by reference herein in their entirety.

The surfactant, as used herein, may be a conventional surfactant known in the art for dispersing non self-dispersing colorants and release agents employed for preparing toner formulations for electrophotography. Commercial surfactants such as the AKYPO series of carboxylic acids from AKYPO from Kao Corporation, Bunka Sumida-ku, Tokyo, Japan may be used. For example, alkyl ether carboxylates and alkyl ether sulfates, preferably lauryl ether carboxylates and lauryl ether sulfates, respectively, may be used. One particular suitable anionic surfactant is AKYPO RLM-100 available from Kao Corporation, Bunka Sumida-ku, Tokyo, Japan, which is laureth-11 carboxylic acid thereby providing anionic carboxylate functionality. Other anionic surfactants contemplated herein include alkyl phosphates, alkyl sulfonates and alkyl benzene sulfonates. Sulfonic acid containing polymers or surfactants may also be employed.

Optional Additives

The toner formulation of the present disclosure may also include one or more conventional charge control agents, which may optionally be used for preparing the toner formulation. A charge control agent may be understood as a compound that assists in the production and stability of a tribocharge in the toner. The charge control agent(s) also help in preventing deterioration of charge properties of the toner formulation. The charge control agent(s) may be prepared in the form of dispersion in a manner similar to that of the colorant and release agent dispersions discussed above. A useful charge control additive is available from Orient Chemical Company under the trade name Bontron.

The toner formulation may include one or more additional additives, such as acids and/or bases, emulsifiers, UV absorbers, fluorescent additives, pearlescent additives, plasticizers, extra particular additives and combinations thereof. These additives may be desired to enhance the properties of an image printed using the present toner formulation. For example, UV absorbers may be included to increase UV light fade resistance by preventing gradual fading of the image upon subsequent exposures to ultraviolet radiations. Suitable examples of the UV absorbers include, but are not limited to, benzophenone, benzotriazole, acetanilide, triazine and derivatives thereof. Commercial plasticizers that are known in the art may also be used to adjust the coalesceing temperature of the toner formulation.

The resulting toner may have an average particle size in the range of 1 μm to 25 μm. The toner may then be treated with a blend of extra particulate agents, including medium silica sized 40-50 nm, large colloidal silica sized with a primary particle size greater than 60 nm, and optionally, alumina, small silica, and/or titania. Treatment using the extra particulate agents may occur in one or more steps, wherein the given agents may be added in one or more steps.

Medium silica may be understood as silica having a primary particle size in the range of 30 nm to 60 nm, or between 40 nm to 50 nm, prior to any after treatment, including all values and increments therein. Primary particle size may be understood as the largest linear dimension through a particle volume. The medium silica may be present in the toner formulation as an extra particulate agent in the range of 0.1% to 2.0% by weight of the toner composition, including all values and increments in the range of 0.1% to 2.0% by weight. The medium silica may also be treated with surface additives that may impart different hydrophobic characteristics or different charges to the silica. For example, the silica may be treated with hexamethyldisilazane, polydimethylsiloxane (silicone oil), etc. Exemplary silicas may be available from Evonik Corporation under the trade name AEROSIL and product numbers RX-50 or RY-50.

Large colloidal silica may be understood as silica having a primary particle size in the range of 70 nm to 120 nm, or between 90 nm to 120 nm, prior to any after treatment, including all values and increments therein. Most colloidal silicas are prepared as monodisperse suspensions with particle sizes ranging from approximately 30 to 100 nm in diameter. Polydisperse suspensions can also be synthesized and have roughly the same limits in particle size. Smaller particles are difficult to stabilize while particles much greater than 150 nanometers are subject to sedimentation. Whereas fumed silica tend to form agglomerates or aggregates, colloidal silica are dispersed more uniformly and in most cases dispersed as individual particles and have significantly fewer agglomerates or aggregates. The large colloidal silica may be present in the toner formulation as an extra particulate agent in the range of 0.1 to 2 wt %, for example in the range of 0.25 wt % to 1 wt % of the toner composition. The large colloidal silica may also be treated with surface additives that may impart different hydrophobic characteristics or different charges to the silica. For example, the large colloidal silica may be treated with hexamethyldisilazane, polydimethylsiloxane, dimethyldichlorosilane, and combinations thereof, wherein the treatment may be present in the range of 1 wt % to 10 wt % of the silica. Exemplary large colloidal silicas are available from Sukgyung AT, Inc.

In one example, the medium silica may be treated with hexamethyldisilazane and the large colloidal silica may be treated with polydimethylsiloxane and vice versa. In another example, the medium silica may be treated with hexamethyldisilazane and the large colloidal silica may be treated with hexamethyldisilazane. In a further example, the medium silica may be treated with polydimethylsiloxane and the large colloidal silica may be treated with polydimethylsiloxane.

The alumina (Al₂O₃) that may be used herein may have an average primary particle size in the range of 5 nm to 20 nm, including between 8 to 16 nm (largest cross-sectional linear dimension). In addition, the alumina may be surface treated with an inorganic/organic compound which may then improve mixing (e.g. compatibility) with organic based toner compositions. For example, the alumina may include an octylsilane coating. The alumina may be present in the range of 0.01% to 1.0% by weight of the toner composition, including all values and increments therein, such as in the range of 0.01% to 0.25%, or 0.05% to 0.10% by weight. An example of the aluminum oxide may be that available from Evonik Corporation under the trade name AEROXIDE and product number C 805.

Small silica may be understood as silica (SiO₂) having an average primary particle size in the range of 2 nm to 20 nm, or between 5 nm to 15 nm (largest cross-sectional linear dimension) prior to any after treatment, including all values and increments therein. The small silica may be present in the toner formulation as an extra particulate agent in the range of 0.1% to 0.5% by weight, including all values and increments therein. In addition, the small silica may be treated with hexamethyldisilazane. Exemplary small silica may be available from Evonik Corporation under the trade name AEROSIL and product number R812.

In addition, titania (titanium-oxygen compounds such as titanium dioxide) may be added to the toner composition as a extra particulate additive. The titania may be present in the formulation in the range of about 0.2% to 1.0% by weight, including all values and increments therein. The titania may include a surface treatment, such as aluminum oxide. The titania particles may have a mean particle length in the range of 1.0 μm to 3.0 μm, such as 1.68 μm and a mean particle diameter in the range of 0.05 μm to 0.2 μm, such as 0.13 μm. An example of titania contemplated herein may include FTL-110 available from ISK USA.

The following examples are provided to further illustrate the teachings of the present disclosure, not to limit the scope of the present disclosure.

Table 1 illustrates an exemplary formulation sheet for making chemically prepared energy efficient toner particles according to the present invention.

TABLE 1

| | Batch | Batch | Batch |
|---|---|---|---|
| Material | Weight (g) | Solids (%) | Solid Wt (g) |
| Neocryl 2980 latex | 441.32 | 30 | 132.40 |
| Neocryl 3025 latex | 66.20 | 40 | 26.48 |
| EM187468 emulsion | 40.78 | 48.70 | 19.86 |
| EM188334 emulsion | 46.95 | 42.30 | 19.86 |
| Wax Dispersion | 60.45 | 24.50 | 14.81 |
| First Magenta dispersion | 52.90 | 23.80 | 12.59 |
| Second Magenta dispersion | 20.64 | 20.33 | 4.20 |
| Ceramer 67 | 29.27 | 25.30 | 7.41 |
| Bontron CCA cake | 39.39 | 23.50 | 9.26 |
| AKYPO RLM100 | 11.19 | 90.00 | 10.07 |
| DI Water | 545.30 | 0.00 | 0.00 |
| 1.0% H2SO4 solution | 569.66 | 0.00 | 0.00 |
| 4% NaOH solution | 75.95 | 0.00 | 0.00 |
| Subtotal | 2000.00 | 12.83 | 246.85 |

An exemplary process for making the chemically processed toner particles as outlined in Table 1 is as follows.

An emulsion comprising about 199 grams of a styrene acrylic emulsion (NE 2980 and NE3025) and a polyester emulsion (EM 187488 and EM 188334) in a ratio of 80:20 percent by weight is mixed with a 10% surfactant solution (AKYPO-RLM-100), a first and second magenta pigment dispersion of 16.79% by weight, and a wax dispersion of 14.81% followed by addition of 545.30 grams of DI water. The agglomerate is poured into a reaction flask and the reactor temperature is held at 30° C. The blended mixture is mixed for 5 minutes after addition of a 1% sulphuric acid solution. After the addition of the 1% sulphuric acid solution, the temperature in the reactor is raised to 56° C. The temperature is then cooled, and the agglomerate is agitated for 10 minutes. The temperature is then raised to 54° C. for 3 hours and cooled. The pH of the mixture is then measured. A 4% NaoH solution is added to obtain the necessary pH of greater than or equal to 7.0. The mixture is then cooled and the toner slurry is poured into a Parr Pressure reactor. The temperature in the Parr Pressure reactor is raised and the mixture is agitated in the reactor for 60 minutes. The Parr Pressure reactor is then cooled and discharged to recover toner particles having a desirable particle size of about 3 to 9 microns and average degree of circularity above 0.95.

Table 2 below shows a summary of T1(C)/T4(C) data for toners having polyester resin emulsions ranging from 10% to 50% by weight. T1 is considered as the initial soften temperature of toner under specified pressure and T4 is representative of a melt flow onset temperature under similar conditions. The test is traditionally used to measure press-melt behavior of toners for laser printer application. Lower T1 and T4 temperatures indicate a lower temperature required to melt the toner and then fuse the toner to the substrate. These lower melt temperatures ultimately lead to more energy efficient toners and printers.

TABLE 2
FLOW TEMPERATURE COMPARISONS

| | | | EM187468 | | |
|---|---|---|---|---|---|
| Toner ID | A2980 | A3025 | EM188334 | T1(° C.) | T4(° C.) |
| F222-3 | 80 | 10 | 10 | 111.6 | 119 |
| F222-5 | 70 | 10 | 20 | 113.3 | 121.2 |
| F225-1 | 60 | 10 | 30 | 111.6 | 119.7 |
| F225-2 | 50 | 10 | 40 | 113.3 | 121.2 |
| F225-3 | 40 | 10 | 50 | 118.5 | 127.2 |

As seen in Table 2, a polyester emulsion between 10 percent to about 40 percent does not influence the T1/T4 toner melt behavior. However, Toner ID 225-3 (a 50% polyester emulsion) triggers a phase inversion of the polymer melt, thereby creating an undesirable complication to the composite structure of the molten polymer mix. The temperatures of T1(° C.) and T4(° C.) of Toner ID F225-3 negatively rise to 118.5° C. and 127.2° C., respectively, when the styrene acrylic emulsion (A2990 and A3025) and polyester emulsion (EM187468/EM188334) are in the ratio of 50:50. However when the ratio of styrene acrylic emulsion to polyester emulsion is in the range of 90:10 to 60:40 (as in Toner ID F222-3, F222-5, F222-1,and F222-2, respectfully), the temperature of T1(° C.) varies from 111.6° C. to 113.3° C. and the temperature of T4(° C.) varies from 119° C. to 121.2° C. Therefore it can be appreciated that the amount of the styrene acrylic resin should be at least 60% by weight of the toner composition. To avoid complication to the composite structure of the molten polymer mix, the ideal range of the styrene acrylic resin to the polyester resin should preferably be in the range of 90:10 to 60:40.

The energy efficient chemically prepared toner of the present invention provides a balance between good low energy fusing behavior as well as resistance to hot offset. This result is be achieved by using an emulsion aggregation process which allows the ability for one to combine various amounts of low molecular weight styrene acrylic emulsion with an emulsion of low melting polyester resin to create toners with low melting temperatures. The creation of these desired toner properties could not be reached using one resin alone. Thus, using various amounts of the styrene acrylic resin emulsion combined with not more than 40% of a polyester resin emulsion, the inventors have discovered the ability to tune the toner particle to achieve the desired balance between resistance to hot offset and energy saving low fusing temperature.

The surface chemistry controlled aggregation used in an emulsion aggregation process allows for commercially available styrene acrylic resin emulsions to be blended with commercially available polyester resin emulsions and then flocculated together along with other ingredients such as colorants and waxes. The immiscibility of the polymer resins does not come into play because melt mixing is not involved and the simple physical mixing of polymers is avoided. Nano particles of each resin chemistry—styrene acrylic and polyester are isolated in an emulsified phase. The particles will flocculate together when the surface chemistry is disturbed. This is typically achieved by pH altering which causes the nano-particles to aggregate into larger particles consisting of the ingredients at their respective ratios, becoming toner particles when the proper size is attained.

Further, when the small portion of the low melt polyester resin is combined with a majority of the styrene acrylic resin, a continuous phase is formed by the styrene acrylic resin melt, while the immiscible polyester resin forms a domain that is not continuous with the styrene acrylic resin matrix. The immiscible polyester resin that melts in the composite acts as a toughening agent similar to other melted toner ingredients such as pigments. This positively affects the melt flow of the toner matrix. This toughening effect by the polyester resin then enhances the resistance to hot offset. The addition of the low melting polyester resin is very similar to that of adding a high molecular weight styrene resin into the toner matrix. Because of the intrinsic immiscibility of the polymers, the low melting polyester resin has very little effect of softening/melting of the styrene acrylic resin majority in the toner matrix. This is unlike the addition of a high molecular weight styrene acrylic resin that would penetrate into low molecular weight styrene acrylic resin and negatively elevate the softening and flow-onset temperature—thereby making the toner less energy efficient.

Thus, when a smaller portion of a low melting polyester is combined with a majority of lower molecular weight styrene acrylic resin, a larger operative fuse window is seen. This larger operative fuse window is achieved by preserving the low melting behavior from the low molecular weight styrene acrylic resin at the low temperature end of the fuse window, while expanding the high temperature end of the fuse window with enhanced resistance to hot offset.

Toners comprising of a styrene acrylic and polyester resin system along with a cyan pigment, magenta pigment, carbon black or yellow pigment were evaluated for their electrophotographic functional performance. Toners were placed in a Cyclomix blender, along with about 0.25% by weight of Aerosil R812, about 0.05% by weight of Aeroxide C805 and blended. Following the blend step, toner was further blended with about 0.25% Aerosil R812, 0.75% by weight of a large colloidal silica obtained from Sukgyung AT, Inc. 2% by weight of Aerosil RY50 and about 0.5% of a titania such as FTL-110 obtained from Ishihara. Toners were then evaluated in a Lexmark C78x printer at about 50 ppm (pages per minute) at lab ambient (72° F./40% RH) environment to about 5000 pages. Results are shown in the Table 3.

TABLE 3

| | | | | Total Toner | Toner-to- |
|---|---|---|---|---|---|
| | Q/M | M/A | Charge/Area | usage | Cleaner |
| Toner | (μC/g) | (mg/cm²) | (nC/cm²) | (mg/pg) | (mg/pg) |
| Example 1 | −47.9 | 0.31 | −15.0 | 8.5 | 0.9 |
| Black | | | | | |
| Example 2 | −45.0 | 0.37 | −16.5 | 8.2 | 1.1 |
| Magenta | | | | | |
| Example 3 | −43.8 | 0.39 | −16.9 | 8.7 | 0.6 |
| Cyan | | | | | |
| Example 4 | −48.4 | 0.34 | −16.6 | 9.2 | 1.1 |
| Yellow | | | | | |

Toners were treated with the surface additives in a two-step format. In the first step, toner was treated with a small silica and alumina, additives that are typically less than about 20 nm and also a large silica. Surface treatment thus carried out can help achieve better surface coverage of the toner and also help mitigate any issues related to filming. Toners corresponding to Cyan, Magenta, Black and Yellow pigments exhibited similar charge over mass and mass per unit area on the developer roll. The low toner-to-cleaner and overall toner usage may be attributed to no filming of cartridge components such as developer roll, doctor blade and also the organic photoconductor drum. Evaluation of these cartridge components namely developer roll, doctor blade, photoconductor drum revealed on signs of filming. Print quality evaluation showed no unusual defects that may be attributed to the modified resin system. If there was poor incorporation of the polyester resin the styrene acrylic resin matrix of the toner, it could have resulted in toner having a tendency to film cartridge components and also resulting in background or high usage. Hence, it may be appreciated that the incorporation of the polyester resin the hybrid system was successful.

It will be apparent to those skilled in the art that it is not intended to be exhaustive or to limit the invention to the precise steps and/or forms disclosed, and obviously many modifications and variations are possible in the light of the above teaching without departing from the spirit and scope of the invention. Thus it is intended that the present invention cover the modifications and variations of this invention provided they come within the scope of the appended claims and their equivalents.

1. A method of forming a chemically processed toner by aggregation in an aqueous medium, the method comprising:
forming a toner resin composition comprising a styrene acrylic emulsion and a polyester emulsion, the styrene acrylic emulsion being at least 60 percent by weight of the toner resin composition; and
combining the toner resin composition with a pigment, fuser release agent and a surfactant to form the chemically processed toner having a particle size of about 3 to 9 microns and an average degree of circularity of about 0.95 or greater.

2. The method of claim 1, wherein the styrene acrylic emulsion is in a range from 60 percent to about 90 percent by weight of the toner resin composition.

3. The method of claim 1, wherein the polyester emulsion is in a range of about 10 percent to 40 percent by weight of the toner resin composition.

4. The method of claim 1, wherein the polyester emulsion in the toner resin composition is less than or equal to 40 percent by weight.

5. The method of claim 1, wherein the styrene acrylic emulsion has a peak molecular weight ranging from about 10,000 to about 35,000.

6. The method of claim 1, wherein the fuser release agent comprises a wax dispersion.

7. The method of claim 1, wherein the chemically processed toner has particles that are spherical or near-spherical in shape.

8. A chemically processed toner for an image forming apparatus comprising:
a toner resin, a colorant, a wax, and a surfactant, the toner resin comprising a polyester resin having a number average molecular weight of about 4000 to about 15000 and at least 60 percent by weight of a styrene acrylic resin having a peak molecular weight of about 10,000 to about 35,000.

9. The toner of claim 1, wherein the ratio of the styrene acrylic resin to the polyester resin is from about 90:10 to about 60:40.

10. The toner of claim 8, wherein the polyester emulsion is less than or equal to 40 percent by weight of the toner resin.

11. The toner of claim 8, wherein the polyester emulsion is in the range of about 10 percent to about 40 percent by weight of the toner resin.

12. The toner of claim 8, wherein the styrene acrylic emulsion has a peak molecular weight ranging from about 10,000 to about 35,000.

13. The toner of claim 8, wherein the particle size is in the range of about 3 to about 9 microns.

14. The toner of claim 8, wherein the colorant is a pigment.
